(19) United States
(12) Patent Application Publication
(10) Pub. No.: US 2012/0187768 A1
(43) Pub. Date: Jul. 26, 2012

(54) LOW FILTER CAPACITANCE POWER SYSTEMS, STRUCTURES, AND PROCESSES FOR SOLAR PLANTS

(76) Inventors: Dimitry Goder, San Jose, CA (US); Eugene Krzywinski, San Jose, CA (US); James Allen, San Jose, CA (US); Troy Speers, Corralitos, CA (US)

(21) Appl. No.: 13/358,342

(22) Filed: Jan. 25, 2012

Related U.S. Application Data
(63) Continuation-in-part of application No. 12/338,610, filed on Dec. 18, 2008, now Pat. No. 8,138,631.
(60) Provisional application No. 61/016,365, filed on Dec. 21, 2007.
(60) Provisional application No. 61/436,518, filed on Jan. 26, 2011.

(51) Int. Cl. H02J 1/00

(52) U.S. Cl. 307/82

(57) ABSTRACT

DC to DC converters are connected in parallel to a DC buss that is input to a DC to AC inverter module. Each of the DC to DC converters receives input from one or more DC electrical sources. The inverter module typically comprises a DC to AC power stage that is connectable to an AC buss, and a filter connected between the DC buss and the DC to AC power stage. The filter may comprise one or more capacitors, wherein the capacitors may be chosen based upon the voltage of the DC buss. While the DC buss may have a voltage ripple associated therewith, the DC electrical sources are protected from the DC voltage ripple by their respective converter modules.

### CROSS REFERENCE TO RELATED APPLICATIONS

This application claims priority to U.S. Provisional Patent Application Ser. No. 61/436,518, entitled Low Filter Capacitance Power Architecture for Solar Plants, filed 26 Jan. 2011, which is incorporated herein in its entirety by this reference thereto.

This application is also a Continuation-in-Part and claims priority for commonly disclosed subject matter to U.S. application Ser. No. 12/338,610, entitled Advanced Renewable Energy Harvesting, filed 18 Dec. 2008, which claims priority to U.S. Provisional Patent Application Ser. No. 61/016,365, entitled Packaging, Assembly, and Mounting of Photovoltaic Solar Panels, filed 21 Dec. 2007, each of which is incorporated herein in its entirety by this reference thereto.

### FIELD OF THE INVENTION

The invention relates generally to the field of renewable energy power production. More particularly, the invention relates to power production, power conversion, and power management of DC energy sources systems.

### BACKGROUND OF THE INVENTION

Coal-burning energy produces some of the highest greenhouse-gas emissions of any of the fuels in widespread use. The United States currently uses coal-burning fuel to provide about half of the country's electric power. The United States is continually striving to find more affordable and efficient ways to generate its own clean energy in an effort to improve the environment and achieve energy independence.

Solar power is one of the cleanest sources of energy available. Sunlight is captured from the sun in the form of electromagnetic radiation, and generated into a direct current (DC) using photovoltaic (PV) cells. The PV cells are made of semiconductors, e.g. silicon, and are fabricated in the form of semiconductor arrays, films, inks, or other materials. The individual PV cells are typically aggregated or otherwise interconnected together, and are then packaged into solar panels of some size and shape, such as within a rugged, environmentally sealed enclosure that is suitable for physical mounting and/or installation on residences, businesses, earth-mounted poles, vehicles, roof-tops, and other locations.

The DC has a current (I) and voltage (V). The relationship between the currents produced by a solar panel or series-connected group of panels and the output voltage may be plotted or graphed on an XY axis as a family of IV curves. The solar panel output current I bears a direct relationship to the spectral power density or level of sunlight (spectral irradiance) illuminating the panel at a given time, and may change dramatically, relative to small changes in irradiance. In the typical case where a plurality of such solar panels are connected in series, the solar panel with the lowest level of current flow dictates or otherwise sets the current flowing throughout the series circuit. Panels connected in series can lose up to 60% of their energy as a result of being limited by the worst performing panel.

The optimal power of a solar panel array is obtained by incorporating a maximum power point tracking (MPPT) algorithm to optimize the overall power available for harvesting, to maintain the power output at the maximum level possible for a given system or string current. Usually, the electronics and any software necessary to implement this MPPT function are incorporated into the implementation of the system's DC-to-AC conversion function (DC-to-AC inverter) in grid-connected photo-voltaic (PV) systems, or as a component of a storage battery charging and control system for off-grid solar applications.

Global MPPT algorithms provide only the average operating point of the total string, not the maximum. An optimized system may provide per panel MPPT functionality, to account for individual panel optimum operating points, as well as variations in panel operating characteristics.

String inverters must be able to accommodate strings of varying numbers of interconnected panels, and a wide variety of panel types. Because of these variations, a traditional DC-to-AC inverter used in a series-connection system is subjected to high stress and heat levels, resulting in a one percent failure rate within the first six months.

The design of conventional series-connected panel systems is time consuming. All panels must be from the same manufacturer, and be of the same model or power rating. Multiple strings of series-connected panels must be of the same length, or contain the same number of panels. Panels with different orientations to the sun S (FIG. 1) must be treated as separate subsystems, and add-ons to an existing installation are treated as additions of a completely separate subsystem.

The maintenance of conventional series-connected panel systems is also time-consuming. When a conventional system is connected in series, any defects in one of the panels will cause the entire system to fail. To locate the defective panel, a technician must test the panels separately. As a result, the cost of hiring a technician to visit the site and locate the defective panel is prohibitively expensive.

It would be advantageous to provide power architecture structures, systems, and associated methods that provide the freedom to use solar panels having any of different IV characteristics, different PV technologies, and/or panels installed at different orientations to the sun S. The development of such structures, systems, and associated methods would be a major technological breakthrough.

It would also be advantageous to provide power architecture structures, systems, and associated methods that provide any of reduced cost or increased reliability for DC-to-AC inverters. The development of such structures, systems, and associated methods would be a major technological breakthrough.

### SUMMARY OF THE INVENTION

DC to DC converters are connected in parallel to a DC buss that is input to a DC to AC inverter module. Each of the DC to DC converters receives input from one or more DC electrical sources. The inverter module typically comprises a DC to AC power stage that is connectable to an AC buss, and a filter connected between the DC buss and the DC to AC power stage. The filter may comprise one or more capacitors, wherein the capacitors may be chosen based upon the voltage of the DC buss. While the DC buss may have a voltage ripple associated therewith, the DC electrical sources are protected from the DC voltage ripple by their respective DC to DC converters.

In one embodiment, the invention provides a separate DC to DC boost converter and maximum power point tracking (MPPT) module for each energy gathering source, e.g. such as but not limited to a solar panel. The MPPT module may preferably match the output impedance of the panels to the input impedance of the DC to DC boost converter, to maximize the power for each panel. The individual converter modules boost output voltage of the panels to a voltage that is high enough to minimize transmission wire losses, while the inverter module efficiently inverts the DC to an AC voltage.

Using a parallel method of interconnecting a number of solar panels with a constant voltage output to a DC buss eliminates the problems associated with using a string of series-connected solar panels. This system allows the current from each individually optimized panel to sum together, to produce a current that is independent of the efficiency or solar conversion capability of any one panel. As a result, the system can continue to function, even with broken panels.

This creates the freedom to use different solar panels with different IV characteristics, panels constructed from different PV technologies, and panels installed at different orientations relative to the sun. In one embodiment, additional panels are added to the installation at any time. In another embodiment, other power sources, e.g. fuel cells, batteries, wind turbines, etc. are coupled to individual converter modules, and attached to the DC buss, for either point of use or DC to AC conversion, such as for use or for sale back to the utility company.

In another embodiment, a communications module is coupled to each panel for monitoring. The monitoring system provides information, such as but not limited to any of panel ID, temperature, voltage, current, power, efficiency, or diagnostics, e.g. for individual users, or for a company that harvests the energy. This information helps technicians immediately identify malfunctioning panels, and maximizes the efficiency of each panel. The monitoring system may also provide information regarding the output and efficiency of the complete system, and may alert the producer of underperformance or problematic power production.

### BRIEF DESCRIPTION OF THE DRAWINGS

is FIG. 1 is a schematic diagram of a conventional solar power system, wherein a plurality of solar panels are connected in series to supply input power to an inverter, which is connected to a power grid;

FIG. 2 is a chart that shows current output as a function of panel voltage for an exemplary solar panel, for different levels of incident radiation;

FIG. 3 is a chart that shows power output as a function of panel voltage of an exemplary solar panel, for different levels of incident radiation;

FIG. 4 is a chart that shows average DC current that is input to an inverter, and corresponding input current that is approximated as a full wave rectified sine wave;

FIG. 5 shows an exemplary idealized waveform for the output current of an inverter with resistive loading;

FIG. 6 shows an exemplary enhanced power architecture with DC to DC boost converters for each of a plurality of DC generation elements that are connected in parallel to a DC bus that is connected to an inverter module;

FIG. 7 shows an exemplary embodiment of boost topology;

FIG. 8 is a partial schematic diagram of an exemplary solar panel system having enhanced DC-DC boost topology;

FIG. 9 is a detailed partial circuit block diagram of an exemplary solar panel system having enhanced DC-DC boost topology;

FIG. 10 is a schematic view of an exemplary enhanced power architecture with DC to DC boost converters for each of a plurality of DC generation elements that are connected in parallel to a DC bus that is connected to an inverter module;

FIG. 11 is a schematic view of an alternate exemplary enhanced power architecture that comprises at least one plurality of DC generation elements that are connected in parallel to a DC to DC boost converter, wherein the DC to DC boost converter is connected to a DC bus that is connected to an inverter module;

FIG. 12 is a schematic view of an alternate exemplary enhanced power architecture that comprises at least one plurality of DC generation elements that are connected in series to a DC to DC boost converter, wherein the DC to DC boost converter is connected to a DC bus that is connected to an inverter module; and

FIG. 13 is a schematic view of an alternate exemplary hybrid enhanced power architecture that comprises different groups of DC generation elements that are connected in parallel and series to respective DC to DC boost converters, which are connected to a DC bus that is connected to an inverter module.

### DETAILED DESCRIPTION OF PREFERRED EMBODIMENTS

FIG. 1 is a schematic diagram 10 of an exemplary conventional solar power system 12, which converts solar energy SE from the sun S into electricity 28, and supplies it to an electrical grid 30. Solar panels 16, e.g. 16a-16k, convert light SE into direct current (DC) voltage 18, wherein power is supplied to an inverter module 20.

The inverter module 20 converts input DC voltage 18 into output AC voltage 28, such as to supply power to a utility power grid 30. During daytime, each solar panel 16 produces energy that is typically delivered to the utility company, via the inverter module 20. During nighttime, i.e. under no light or low light conditions, the power plant 12 is idle.

The DC voltage output level of each panel 16 depends on the panel type and its manufacturer, and can typically be between 20V and 120V. The output voltage from a single panel 16 is insufficient for powering a conventional inverter module 20, which commonly requires DC input 18 to be in the range of 250V to 1000V. Therefore, individual solar panels 16, e.g. 16a-16k, are connected in a series configuration 14, where their individual voltages are summed together, thus forming a string 14 that produces a higher DC voltage 18. The specific number of panels 16 in a string 14 depends on the voltage rating for each of the panels 16, and the input voltage range of the inverter module 20. To maximize the energy output 28 from the power plant 10, the inverter module 20 is required to maintain an optimal voltage level 18 at its input terminal 19, and consumes optimal current.

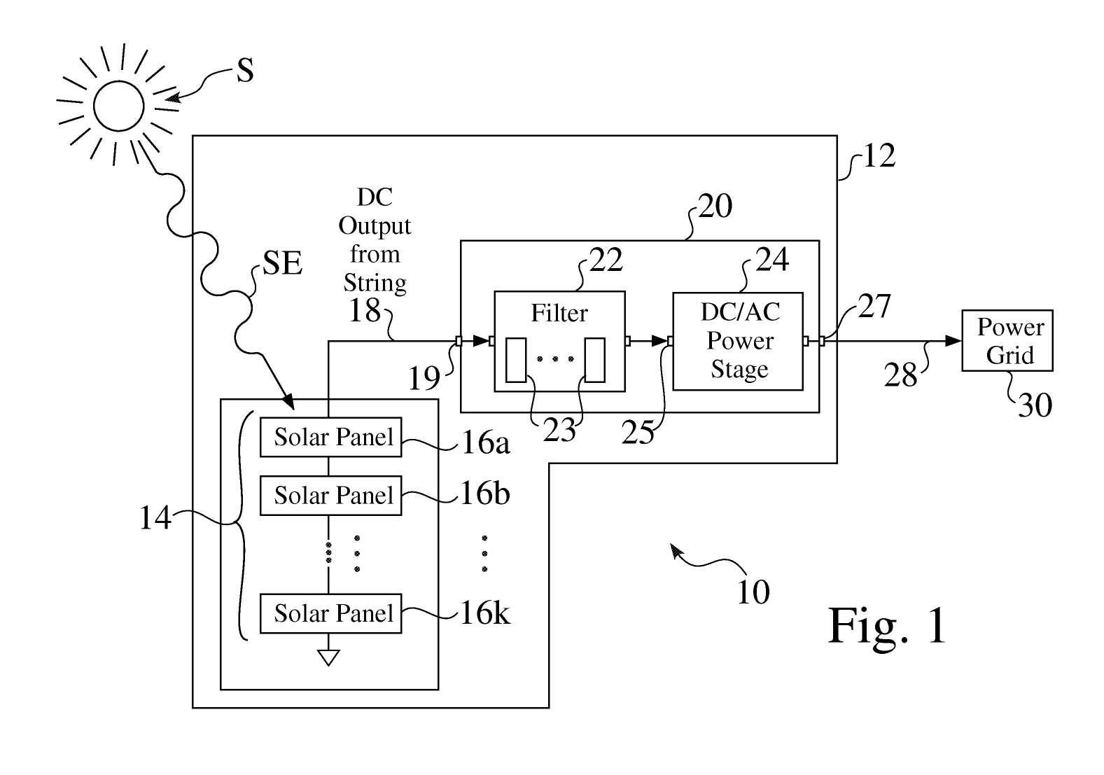

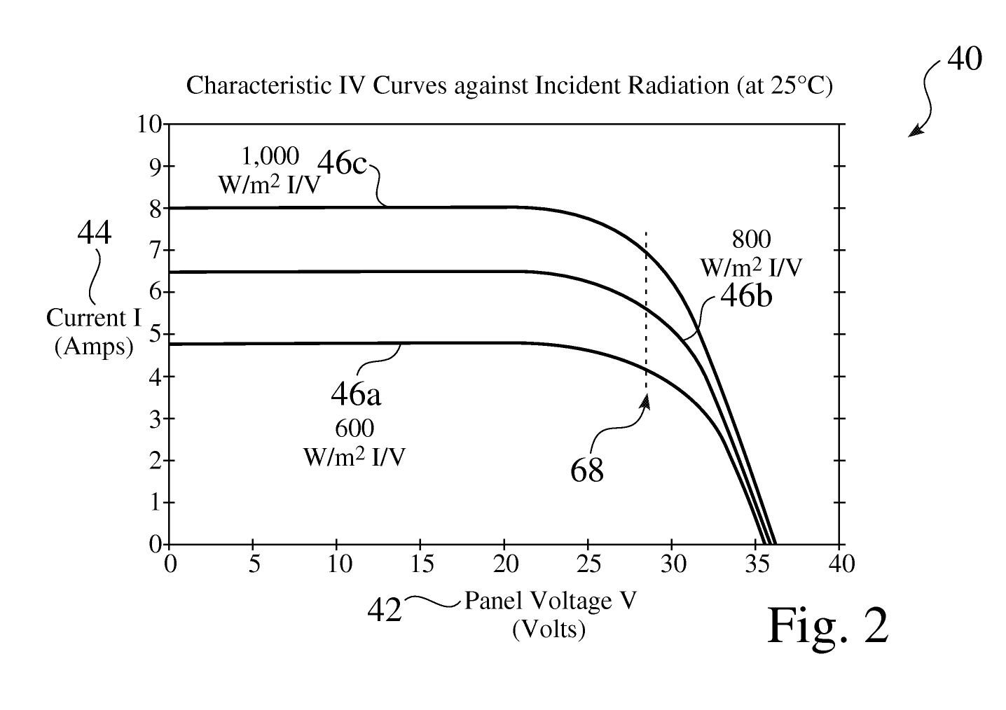

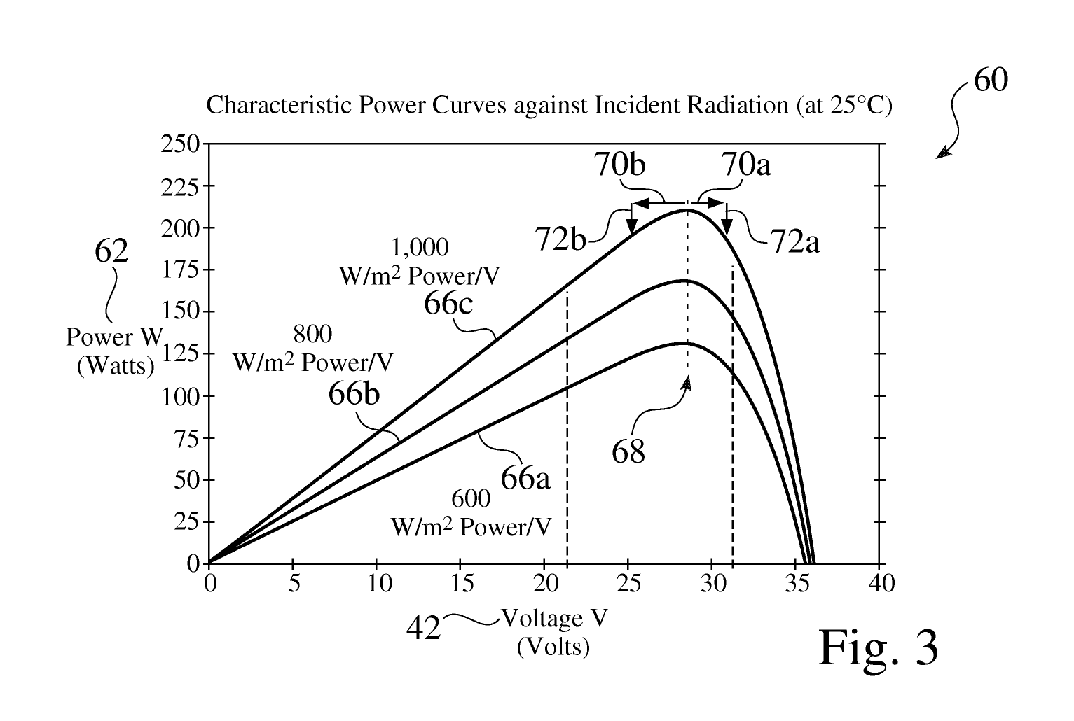

FIG. 2 is a diagram 40 that shows current output 44 as a function of panel voltage 42 for an exemplary solar panel 16 at three levels of incident radiation, i.e. irradiance SE. FIG. 3 is a chart 60 that shows power output 62 as a function of panel voltage 42 for the exemplary solar panel 16 of FIG. 2, at three levels of incident radiation, i.e. irradiance SE.

To obtain maximum power output 62 from the exemplary solar panel 16 of FIG. 2 and FIG. 3, it is required to maintain a specific panel voltage 42 as well as a specific output current 42. For example, as seen in FIG. 3, the maximum power point 62 is achieved at a peak panel voltage 68 of around 28 volts, with current 42, depending on irradiance SE. Under full sun conditions 46c,66c, the maximum power point 68 corresponds to approximately 210 watts. As seen in FIG. 3, any deviation 70, e.g. 70a,70b, from the exemplary maximum power point 62 of around 28 volts results a reduction 72, e.g. 72a,72b in panel output power 62.

The inverter module 20 seen in FIG. 1 operates upon DC energy 18 received from the solar power string 14, and supplies output energy 28 to an AC line, e.g. a power grid 30. The AC line usually represents a sine wave AC circuit, such as having a frequency of 50 Hz or 60 Hz, depending on geographical location.

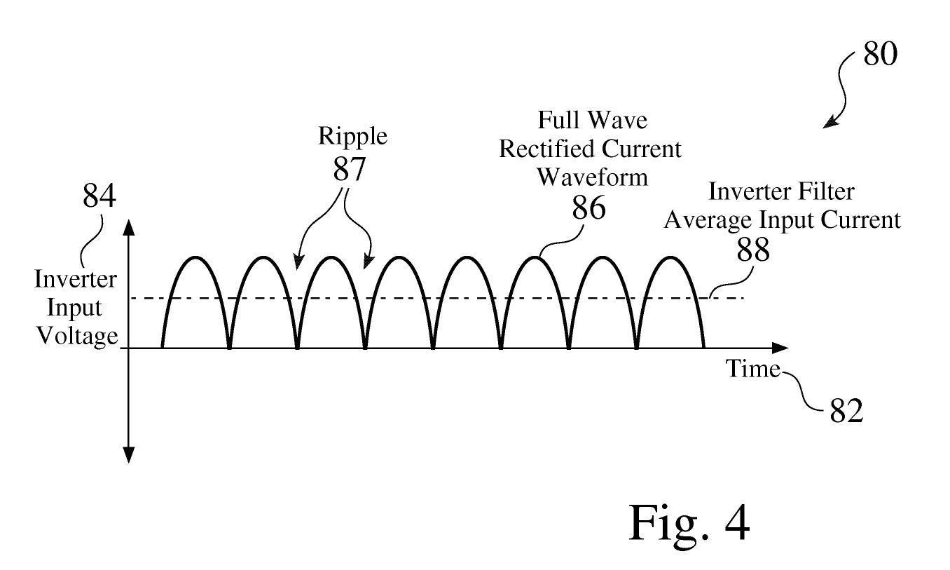

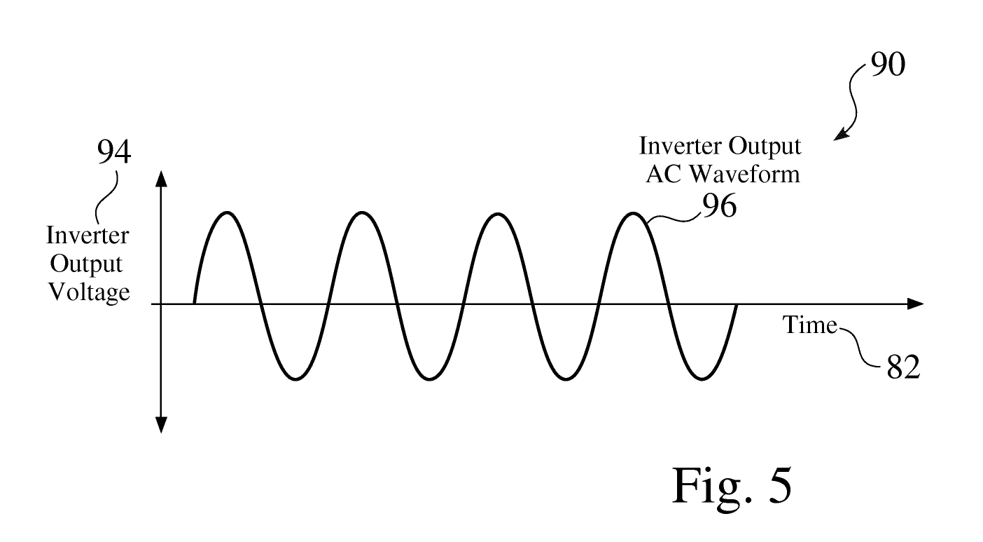

FIG. 4 is a chart 80 that shows exemplary voltage 84 associated with average DC current 88 that is input to an inverter module, e.g. inverter 20, and for corresponding input current that is approximated as a full wave rectified sine wave 86. FIG. 5 is a chart 90 that shows an exemplary idealized waveform 96 of the voltage 94 for the output current 28 of an inverter module 20 with resistive loading.

The output current 28 is supplied by the inverter power stage 24 (FIG. 1), which converts DC input voltage 18 to AC output voltage 28. In the circuit seen in FIG. 1, current input to the power stage 24 can be approximated as a full wave rectified sine wave similar to 86 (FIG. 4).

However, the maximum power point 62 for each solar panel 16 requires a relatively constant load current level, such that the current shape 86 is not acceptable. To address this issue, the inverter module 20 further comprises an input filter circuit 22 (FIG. 1), which converts a full wave rectified current 86 into a relatively constant current 88 (FIG. 4).

The main filtering component of the filter 22 is constructed with capacitors 23 (FIG. 1). However, due to relatively low AC frequencies of 50 Hz or 60 Hz, conventional filters 22 require very large values of capacitance, e.g. such as but not limited to about 3,000 to 4,000 microfarads, which vary depending on the power rating of the inverter module 20. Since the filter 22 is exposed to the full inverter input voltage 18, reaching as high as 1000 volts, these capacitors 23 are very expensive and bulky.

In addition, conventional filters 22 typically use aluminum electrolytic capacitors 23, which presently represent the most practical technology to produce high capacitance values at high voltages. However, such electrolytic capacitors 23 fundamentally exhibit low reliability, such as due to one or more known wear-out mechanisms, e.g. electrolyte depletion, which often results in a significant reduction of the expected life of the inverter module 20.

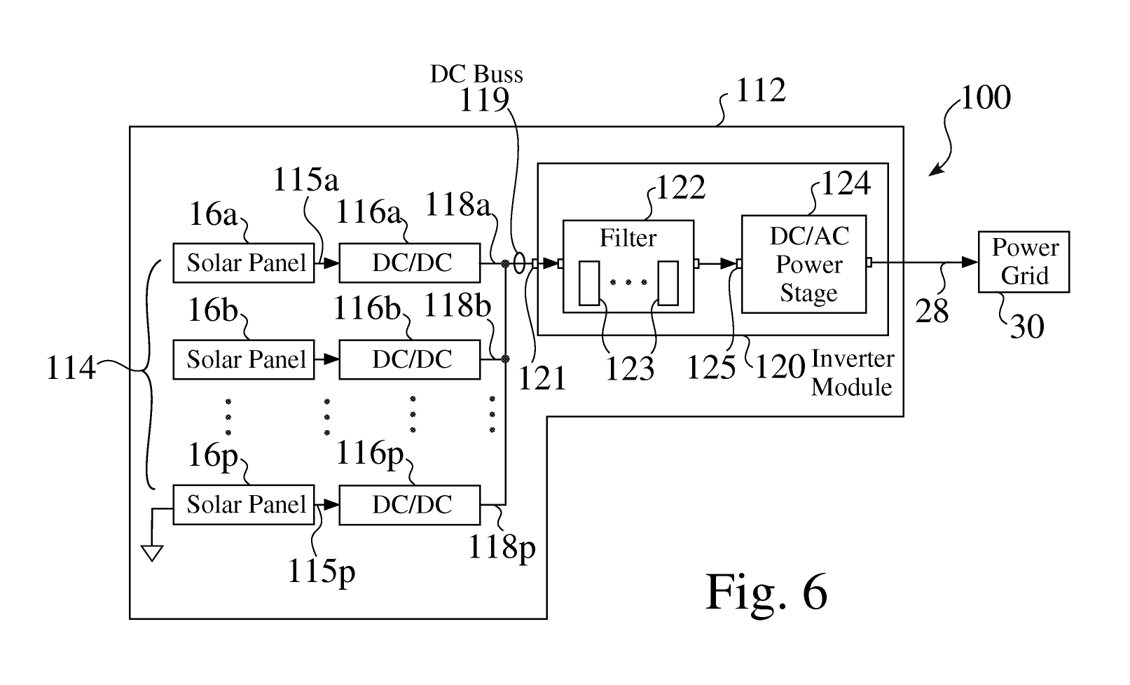

Enhanced Power Architectures. FIG. 6 shows a simplified schematic view of an exemplary enhanced power architecture 100. In the exemplary system 100 seen in FIG. 6, each individual solar panel 16, e.g. 16a, of an array 114 of solar panels 16, e.g. 16a-16n, is connected to the input of a corresponding DC to DC converter 116, e.g. 116a. The output of each of the DC to DC converters 116 is connected to the input of an enhanced inverter module 120, through a DC buss 119.

Each of the converters 116 provides a step-up conversion, from the relatively low voltage 115 produced by the solar panel 16, to a higher DC voltage 118 that is required as an input voltage 118 for the inverter module 120, even though specific voltage levels 115, e.g. 115a and 115b, might vary greatly between panels 116, e.g. 116a and 116b. For example, a panel DC output voltage 115a of 30 volts that is produced by panel 16a may be converted, through DC to DC converter 116a, to a converter output voltage 118a to a 500 volt level, which is connected directly to the input 121 of the inverter module 120.

In the enhanced power architecture 100, the filter circuit 122 may be significantly reduced. Since the input to the inverter power stage 124 input current is still a full wave rectified sine wave 86, the reduction in filter 122 capacitance 123 causes an increased voltage ripple 87 on the high voltage DC bus 119.

However, as long as the peak-to-peak voltage ripple 87 on the DC bus 119 is kept within an input voltage rating of the inverter module 120, the inverter module 120 will operate within its specifications. This input voltage range depends on specific inverter design and, in some exemplary embodiments, may be between 280 volts and 550 volts.

In the enhanced power architecture 100, the solar panels 16 are not directly connected to the DC bus 119, and are not therefore exposed to the voltage ripple 87. As seen in FIG. 6, each of the DC to DC converters 116, e.g. 116a-116p, act as power conversion circuits, which ensures that the maximum power is delivered by each solar panel 16. As well, since ambient conditions, e.g. such as but not limited to available light, shading, and/or temperature, typically vary very slowly, the power delivered by each of the panels 16 is substantially constant. This constant energy is then supplied, through the DC to DC boost converters 116, to the DC bus 119.

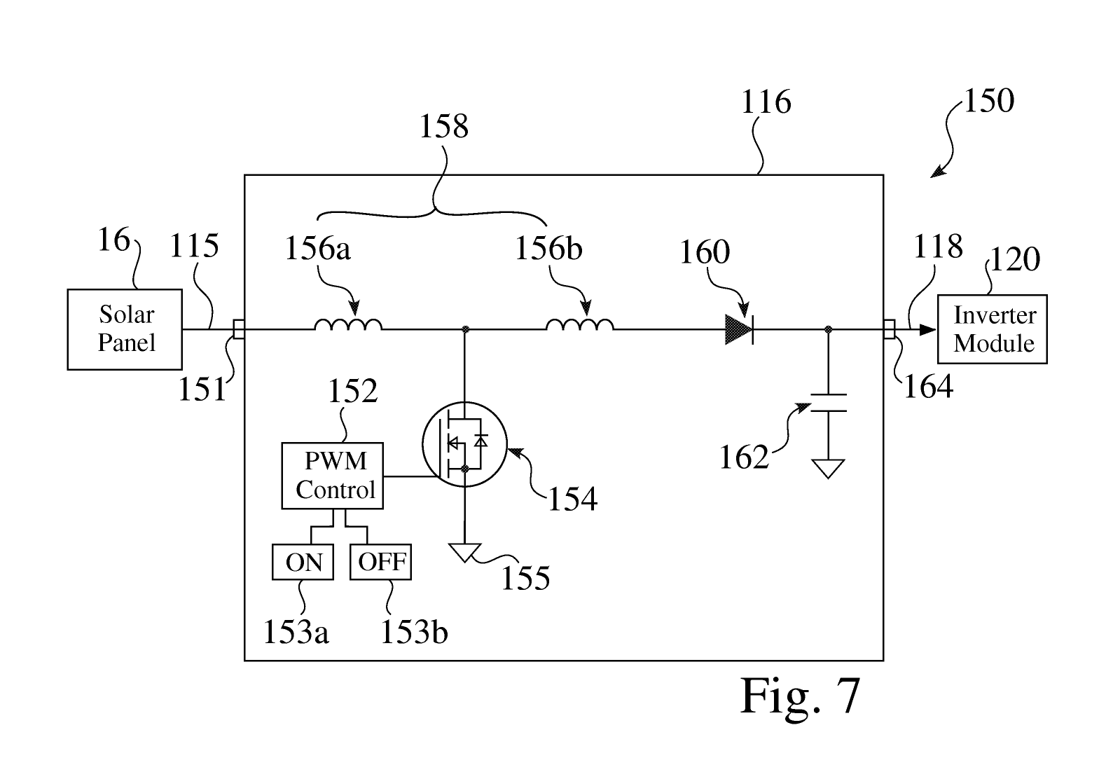

FIG. 7 is a simplified schematic diagram of an exemplary power topology 150 for a DC to DC converter 116. The exemplary power topology 150 seen in FIG. 7 comprises a tapped inductor boost topology. While the power topology 150 seen in FIG. 7 represents en exemplary implementation of the DC to DC converter 116, it should be understood that the converter 116 may alternately be implemented through a wide variety of topologies.

In the exemplary power topology 150 seen in FIG. 7, a pulse width modulation (PWM) control block 152 determines the ON and OFF time of the main power switch 154. During an ON time 153a, the primary side 156a of the transformer 158 is connected between the solar panel 16 and ground 155, thereby storing inductive energy, and the diode 160 is reverse biased.

During an OFF time 153b of the main power switch 154, energy stored in the transformer 158 passes through the diode 160, which is forward biased, and is delivered to the output 164. The energy stored in the transformer 158 during the ON time 153a approximately equals the energy derived from the solar panel 16, and is a function of PWM frequency, ON time duration and solar panel voltage 42.

The PWM control block 152 may preferably adjust one or more operating parameters, e.g. the ON time 153a and/or OFF time 153b, such as to maximize the power delivered by the solar panel 16, under specific ambient conditions. Once adjusted, these operating parameters may preferably stay fixed, such as until one or more ambient conditions change.

With fixed operating conditions and steady ambient conditions, the DC power extracted from the solar panel 16 remains relatively constant. For a high efficiency DC to DC converter 116, the output power of the DC to DC converter 116 approximately tracks the input power. However, it does not determine the actual output voltage. The DC to DC converter 116 simply acts as a constant power source. In the presence of high output voltage ripple 87 on the DC bus 119, the output current maintains constant output power, which is a product of both the voltage and current.

The use of dedicated DC to DC converters 116 therefore extracts maximum available power from corresponding solar panels 16, and keeps the electrical operating conditions, i.e. the current and voltage, for each of the panels 16 at a constant level, while creating a high voltage DC bus 119 that can tolerate high peak-to-peak voltage ripple 87.

The ability to operate with high voltage ripple 87 provides a significant reduction in the complexity of the filter 124, and eliminates the need for expensive, e.g. aluminum, electrolytic capacitors 23, such that the filter 122 may comprise one or more alternate filters 123, to provide any of decreased cost and/or increased reliability. The enhanced power architecture 100 therefore inherently addresses prior restraints and limitations for inverters, and reduces the requirements for inverter filters 122.

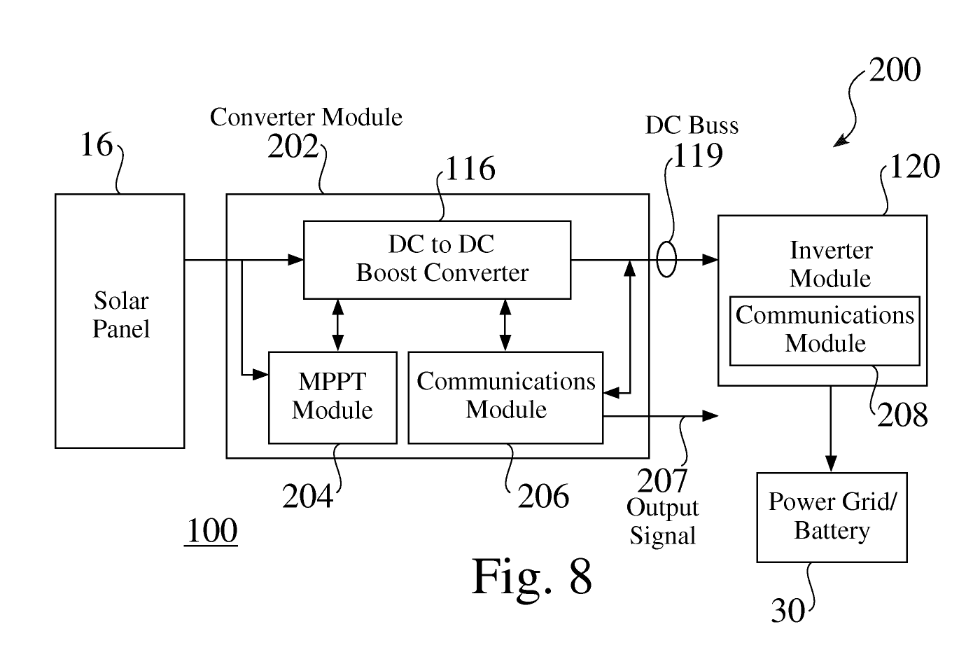

FIG. 8 is a partial schematic diagram 200 of an exemplary solar panel system 100 having an enhanced DC to DC boost converter 116. While the exemplary solar panel system 100 seen in FIG. 8 obtains power from solar panels 16, e.g. 16a-16p (FIG. 6), the power may be obtained from any of solar energy, wind energy, hydroelectric energy, fuel cells, one or more batteries, other DC sources, or any combination of these sources. Therefore, while the exemplary system 100 is discussed with reference to solar panels 16, the system architecture is readily applied to other energy sources.

In the exemplary system 100 seen in FIG. 8, each solar panel 16 is coupled to an individual converter module 202. The converter module 202 receives the electrical power output from the solar panel 16. The converter module 202 comprises a DC to DC boost converter 116, a MPPT module 204, and a communication module 206. The MPPT module 204 determines the maximum power point, such as by using an MPPT algorithm. The DC to DC boost converter 116 converts the incoming electrical power from the solar panel 16, to a higher voltage and lower current, for transmission, via the DC power buss 119, to the inverter module 120. The communication module 206 collects information about the solar panel 16 and/or the converter module 202, e.g. such as but not limited to any of panel identification, voltage, current, power, temperature, diagnostic information, or any combination thereof.

The inverter module 120 converts the electrical power from DC to AC, to be transferred to the power grid 30, or to a battery 30 for storage. Information about the solar panel 16 and converter module 202 collected by the communications module 206, e.g. such as but not limited to any of panel ID, temperature, voltage, current, power, efficiency, diagnostics, and/or other parameters, may preferably by transmitted 207, e.g. wired or wirelessly, to a corresponding communication module 208 associated with the inverter module 120.

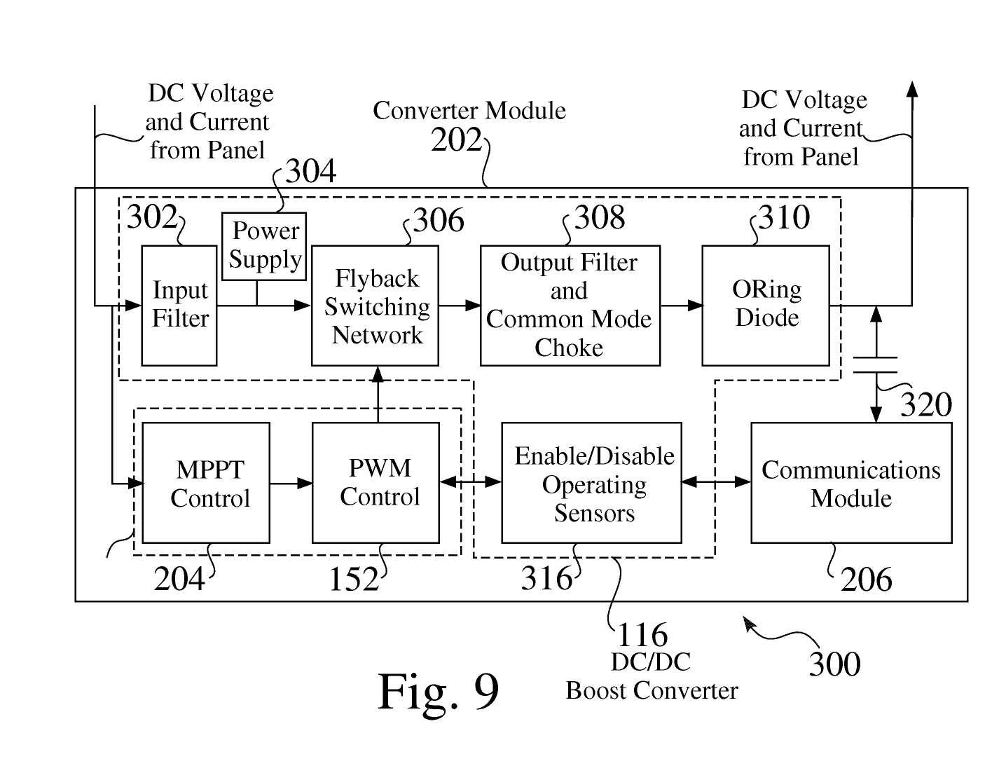

FIG. 9 is a detailed partial circuit block diagram 300 of an exemplary converter module 202 for a power generation system 100 having an enhanced DC to DC boost converter 116. The exemplary DC to DC boost converter 116 seen in FIG. 9 comprises an input filter 302, an auxiliary power supply 304, e.g. +/−12 volts, a flyback switching network 306, an output filter and common mode choke 308, an ORing diode 310, and one or more enable/disable operating sensors 316.

The converter module 202 receives a variable DC input voltage and current from a power module 16, and converts it to an output power at a voltage level determined by the DC buss 119, such as set by the inverter module 120. The input filter 302 performs electromagnetic interference filtering, from the flyback switching network 306 back to the solar panel 16. The auxiliary power supply 304 provides internal power for the various circuits within the converter module 202.

The output filter and common mode choke 308 provides electromagnetic interference filtering out to the DC buss 119, and also prevents the communication signal, e.g. a wired or wireless output signal 207 (FIG. 8), from being absorbed by the filter components. The output is then connected to the DC buss 119, such as via an ORing diode 310, which prevents power backfeed from the DC buss 119 to the converter module 202.

The MPPT module 312 comprises an MPPT control 204 and a pulse width modulator (PWM) 152. The MPPT control 204 determines the output impedance of the panel 16, and matches the input impedance of the flyback switching network 306 via the PWM 152, for maximum power transfer. The MPPT control 204 may preferably comprise an autoranging feature that allows panels 16 of differing output voltages and currents to be used on the same DC buss 119. The output of the panel 16 is sensed, and the appropriate operating range is selected. In one embodiment, the flyback switching network 306 boosts the input voltage until power begins flowing onto the DC buss 119. Output power to input power efficiencies of greater than 95% have been realized using this topology.

The enable/disable operating sensors module 316 performs circuit function tests, such as temperature, voltage and current, to ensure operation within the safe operating specifications of the converter module 202. Power up sequencing includes checking for an enable signal from the inverter module 120, such as via the DC buss 119 and the communications module 206, before enabling the PWM 152 and the flyback switching network 306. When disabled, the converter module 202 is in an OFF state, and has zero output voltage and current. The enable/disable module 316 may also internally limit the output voltage, to prevent runaway and destruction of the circuit. In one embodiment, this voltage limit is set at 375V. If the enable signal, such as from the inverter 120,124 is lost, the PWM 152 and flyback switching network 306 are immediately disabled, and the excess voltage and current are bled off in a controlled manner.

In one embodiment, the communications module 206, i.e. the physical layer, is capacitively coupled 320 to the DC buss 119 via a radio frequency (RF) carrier for power line communication to the inverter 120. Other physical layer embodiments may preferably comprise inductive coupling to the DC Buss 119, and/or wireless communications between the converter module 202 and the inverter module 120 or the inverter power stage 124. In some system embodiments 100, the communications protocol may preferably be implemented using a controller area network (CAN) bus.

Regardless of the input voltage and current, in this embodiment, the output is always the same, so that multiple converter modules 202 can be connected in parallel to sum the power of each panel 16. The power control loop is unregulated, so that the DC buss 119 determines the output voltage of the converter modules 202. In this manner, all paralleled converter modules 202 regulate to the voltage of the DC buss 119, which may preferably be set by the inverter 120,124, such as according to its operating requirements.

In conventional string topologies, the panels 16 are connected in a series string, wherein the system performance is determined by the lowest performing panel. In traditional topologies, a single panel fault or disconnect brings down the entire string.

In contrast to conventional string topologies, by connecting panels 16 in parallel and performing per panel maximum power point (MPPT) operation, each panel 16 operates as an independent power producer from any other panel within the system. In this way, power loss due to temperature effects, shading, panel fault or disconnect, is limited to the affected panel 16, and the power loss is minimized.

Although the systems, structures and methods of use are described herein in connection with exemplary solar power environments, such as to decrease the design requirements for filters associated with power inverters, the structures and techniques can be implemented for a wide variety of applications and environments, or any combination thereof, as desired.

Alternate System Configurations Having Enhanced DC to DC converters and High Voltage DC Bus. While some of the exemplary embodiments of the enhanced power system 100 disclosed herein are described in regard to DC generation elements 16, e.g. solar panels 16, that each have corresponding DC to DC converters 116 and/or converter modules 202 that are connectable to a DC buss 119, a wide variety of alternate systems 100 may be configured using DC to DC converters 116 and/or converter modules 202 and one or more DC busses 119 that are located between the converters 116 and the inverter modules 120.

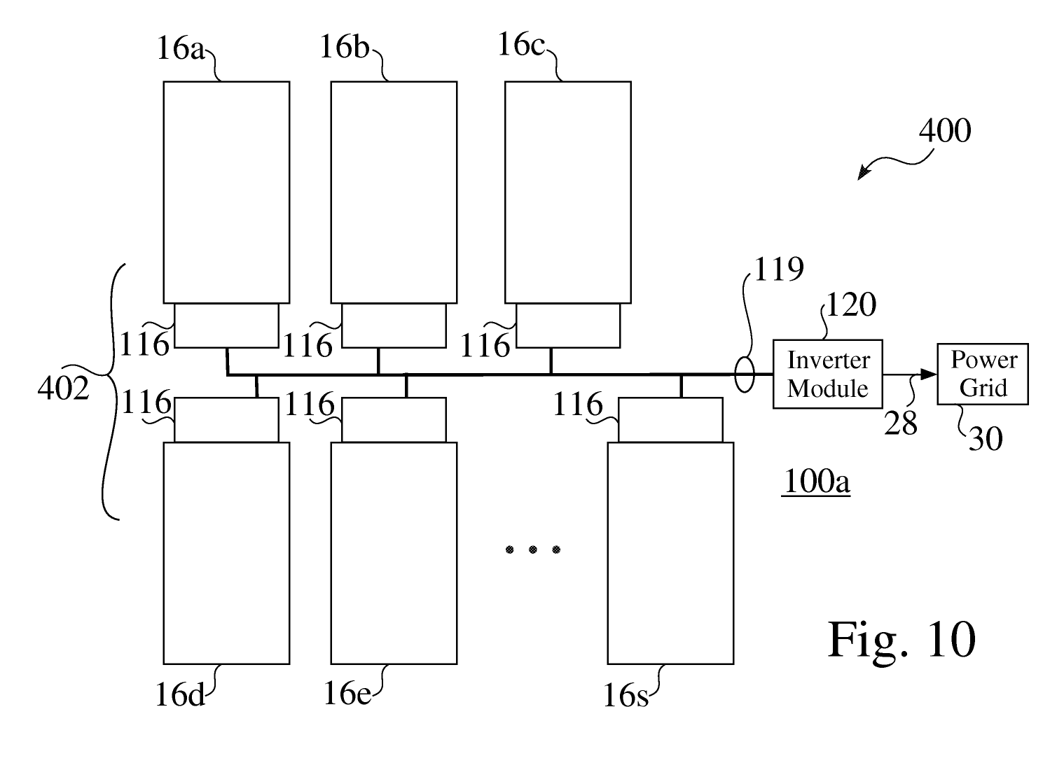

FIG. 10 is a schematic view 400 of an exemplary enhanced power architecture 100a with DC to DC boost converters 116 that are correspondingly paired 402 with a plurality of DC generation elements 16, e.g. 16a-16s, that are connected in parallel to a DC bus 119 that is connected to an inverter module 120.

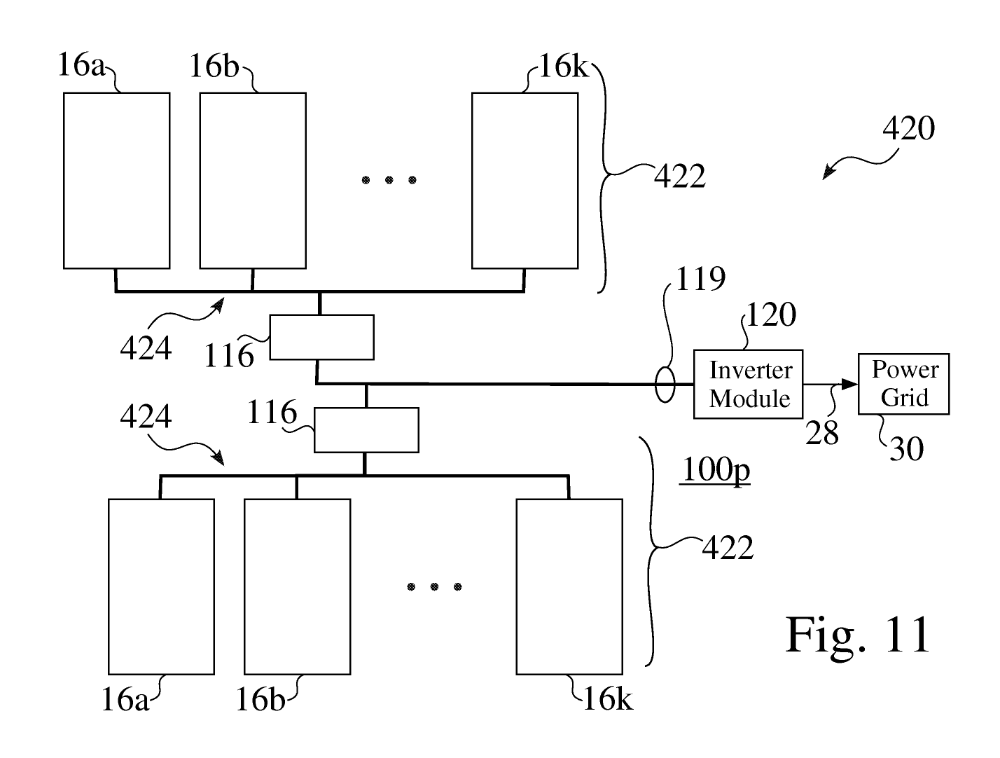

FIG. 11 is a schematic view 420 an alternate exemplary enhanced power architecture 100p that comprises at least one plurality 422 of DC generation elements 16, e.g. 16a-16k, that are connected in parallel 424 to a DC to DC boost converter 116, wherein the DC to DC boost converter 116 is connected to a DC bus 119 that is connected to an inverter module 120.

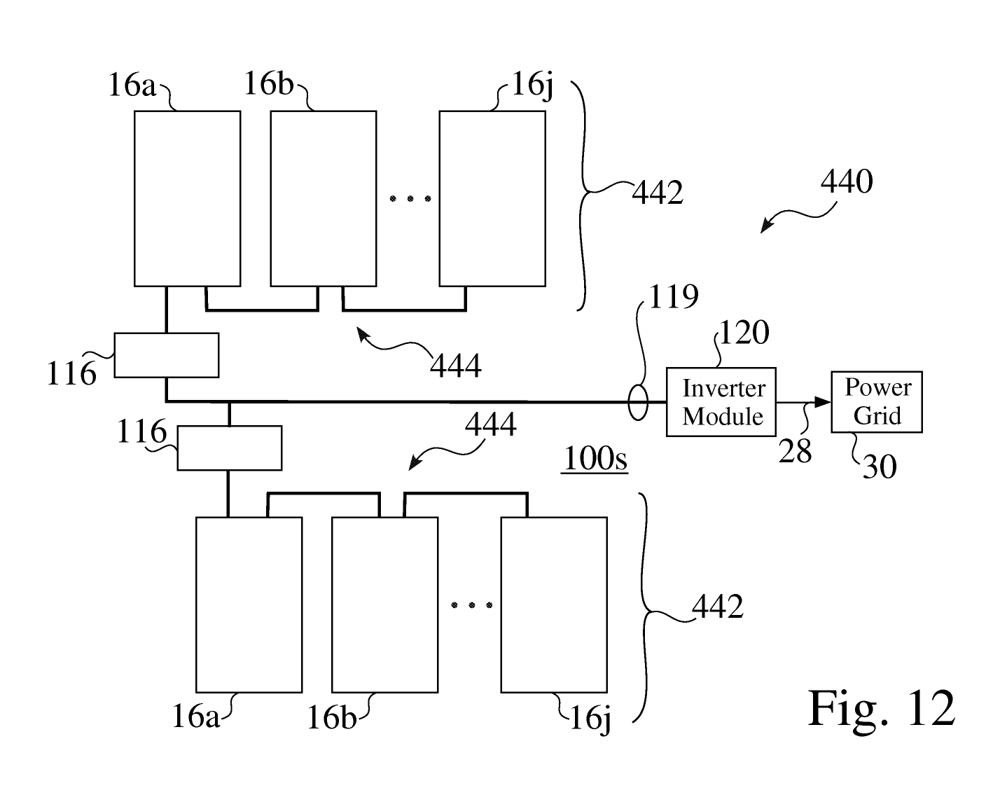

FIG. 12 is a schematic view 440 an alternate exemplary enhanced power architecture 110s that comprises at least one plurality 442 of DC generation elements 16, e.g. 16-16j, that are connected in series 444 to a DC to DC boost converter 116, wherein the DC to DC boost converter 116 is connected to a DC bus 119 that is connected to an inverter module 120.

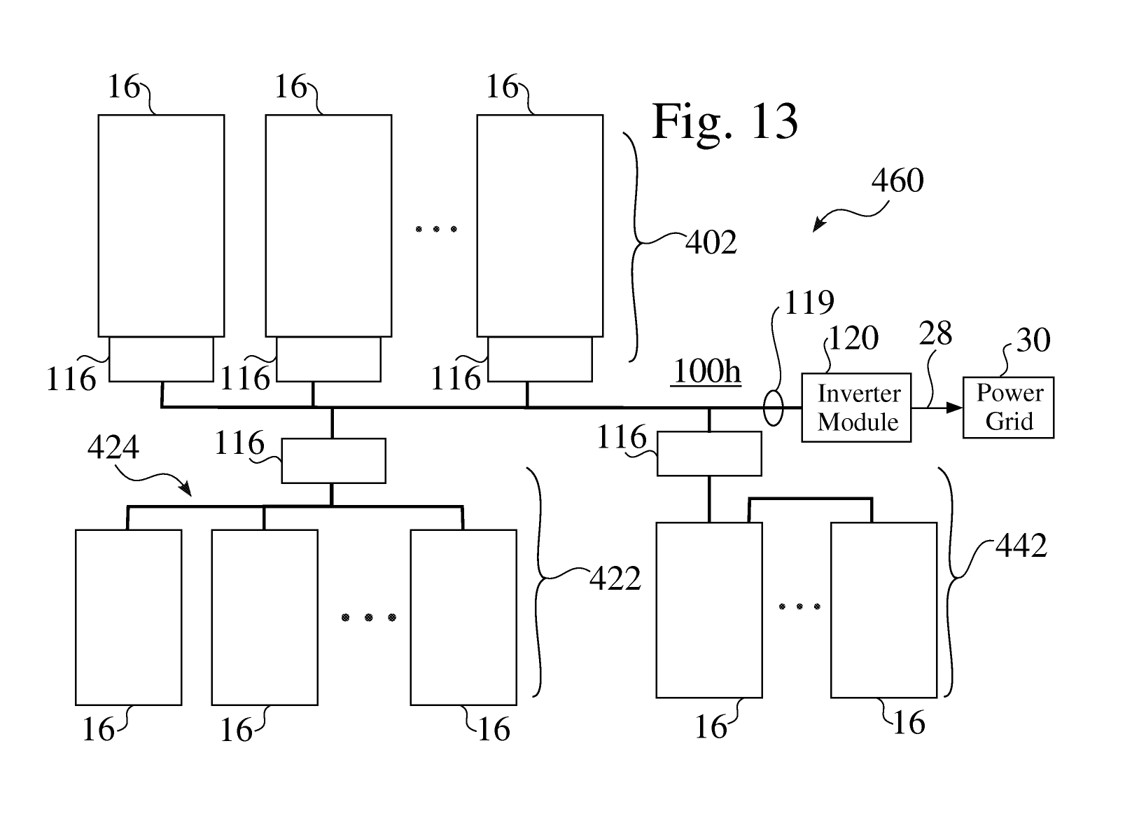

FIG. 13 is a schematic view 460 of an alternate exemplary hybrid enhanced power architecture 100h that comprises different groups, e.g. 402, 422, and/or 442, of DC generation elements 16 that are connected in parallel and series to respective DC to DC boost converters 116, which are connected to a DC bus 119 that is connected to an inverter module 120.

The specific system configuration 100 chosen for a particular application may be based on a wide variety of factors, such as based upon available DC panels 16, DC to DC boost converters 116, and/or inverter modules 120. In some system embodiments, system hardware is configured such that the DC to DC boost converters 116 operate at close to their power rating. For solar panels 16 having relatively small power but with high voltage, e.g. 70 to 100 vdc, such as for thin film panels, a parallel arrangement may be preferred. For solar panels 16 having relatively small power as well as relatively low voltage, e.g. 20 to 50 vdc, such as for liquid crystal panels, a series arrangement may be preferred.

Accordingly, although the invention has been described in detail with reference to a particular preferred embodiment, persons possessing ordinary skill in the art to which this invention pertains will appreciate that various modifications and enhancements may be made without departing from the spirit and scope of the claims that follow.

What is claimed is:

1. A power generation system, comprising:
a direct current (DC) buss having a DC buss voltage;
an inverter module comprising
an input connected to the DC buss for receiving the DC from the DC buss,
an inverter for inverting the received DC to an alternating current (AC), and
an output for outputting the AC to an AC buss;
a plurality of energy receiving modules each configured for outputting direct current (DC) from energy received from at least one energy source;
a plurality of converter modules, wherein each of the converter modules comprises
an inlet connected to one or more of the energy receiving modules,
an outlet connected to the DC buss, and
a DC to DC boost converter located between the inlet and the outlet, wherein the DC to DC boost converter is configured to upconvert the DC from the connected one or more energy receiving modules to the DC buss voltage.

2. The power generation system of claim 1, wherein the boost converter in each respective converter module operates the converter module as an independent power producer by converting the DC voltage and current received from the connected one or more energy receiving modules to an output power at a voltage determined by the DC buss.

3. The power generation system of claim 1, wherein the one or more energy receiving modules connected to the inlet of each of the plurality of converter modules comprises one of the energy receiving modules.

4. The power generation system of claim 1, wherein the one or more energy receiving modules connected to the inlet of each of the plurality of converter modules comprises modules connected to the inlet of each of the plurality of converter modules comprises a plurality of energy receiving modules that are connected in parallel to the corresponding converter module.

5. The power generation system of claim 1, wherein the one or more energy receiving modules connected to the inlet of each of the plurality of converter modules comprises a plurality of energy receiving modules that are connected in series to the corresponding converter module.

6. The power generation system of claim 1, wherein the inverter module comprises a DC to AC power stage that is connectable to the AC buss, and a filter connected between the DC buss and the DC to AC power stage.

7. The power generation system of claim 1, wherein the filter comprises one or more capacitors, wherein the capacitors are chosen based upon the voltage of the DC buss.

8. The power generation system of claim 1, wherein the DC buss has a DC voltage ripple associated therewith, and wherein each of the energy receiving modules are protected from the DC voltage ripple by their respective converter modules.

9. The power generation system of claim 1, wherein the DC buss voltage is set by the inverter module.

10. The power generation system of claim 1, wherein each of the converter modules comprises any of:
an input filter for filtering electromagnetic interference and reducing voltage and current ripple backfeed from the DC to the corresponding one or more energy receiving modules;
a switching network for upconverting the DC voltage from the corresponding one or more energy receiving modules to the DC buss voltage;
an output filter for any of
filtering electromagnetic interference, and
reducing the DC voltage and current ripple to the DC buss;
an ORing module for preventing backfeed from the DC buss into the converter module; or
a common mode choke for facilitating power line communications via radio frequency (RF) signals superimposed onto the DC buss.

11. The power generation system of claim 1, wherein each of the power converter modules comprises a maximum power point tracking (MPPT) module for real time determination of an output impedance of the corresponding one or more energy receiving modules, wherein the MPPT module varies an operating point of the boost converter to match the impedance of the DC from the corresponding one or more energy receiving modules.

12. The power generation system of claim 11, wherein each of the MPPT modules further comprises:
an MPPT control for generating a maximum power point for the DC; and
a pulse width modulator for matching an input impedance of the converter module to an output impedance of the corresponding one or more energy receiving modules.

13. The power generation system of claim 1, further comprising:
a communication module for gathering information about one or more of the energy receiving modules.

14. The power generation system of claim 13, wherein the communication module is configured to transmit any of a wired or wireless signal that corresponds to the gathered information.

15. The power generation system of claim 13, wherein the information gathered by the communication module comprises at least one of:
temperature, voltage, power, current, efficiency, and diagnostics of one or more of the energy receiving modules.

16. The power generation system of claim 13, wherein the communication module is configured to receive one or more inputs.

17. The power generation system of claim 13, wherein the communication module is configured to transmit instructions to one or more of the converter modules to deactivate the corresponding converter module's output in response to any of user input, loss of an enable signal from the inverter, disconnection from the DC buss, or disconnection of the inverter from the DC buss.

18. The power generation system of claim 1, wherein the energy receiving modules comprise solar panels.

19. The power generation system of claim 1, wherein the energy receiving modules receive energy from at least one of solar power, wind energy, hydroelectric energy, a fuel cell, and a battery.

20. A method, comprising the steps of:
providing a power generation system comprising
a direct current (DC) buss having a DC buss voltage,
an inverter module comprising
an input connected to the DC buss for receiving the DC from the DC buss,
an inverter for inverting the received DC to an alternating current (AC), and
an output for outputting the AC to an AC buss;
a plurality of energy receiving modules each configured for outputting direct current (DC) from energy received from at least one energy source;
a plurality of converter modules, wherein each of the converter modules comprises
an inlet connected to one or more of the energy receiving modules,
an outlet connected to the DC buss, and
a DC to DC boost converter located between the inlet and the
a DC to DC boost converter located between the inlet and the outlet, wherein the DC to DC boost converter is configured to upconvert the DC from the connected one or more energy receiving modules to the DC buss voltage; and
connecting the output of the inverter module to an AC buss.

21. The method of claim 20, wherein the boost converter in each respective converter module operates the converter module as an independent power producer by converting the DC voltage and current received from the connected one or more energy receiving modules to an output power at a voltage determined by the DC buss.

22. The method of claim 20, wherein the one or more energy receiving modules connected to the inlet of each of the plurality of converter modules comprises one of the energy receiving modules.

23. The method of claim 20, wherein the one or more energy receiving modules connected to the inlet of each of the plurality of converter modules comprises a plurality of energy receiving modules that are connected in parallel to the corresponding converter module.

24. The method of claim 20, wherein the one or more energy receiving modules connected to the inlet of each of the plurality of converter modules comprises a plurality of energy receiving modules that are connected in series to the corresponding converter module.

25. The method of claim 20, wherein the inverter module comprises a DC to AC power stage that is connected to the AC buss, and a filter that is connected between the DC buss and the DC to AC power stage.

26. The method of claim 25, wherein the filter comprises one or more capacitors, wherein the capacitors are chosen based upon the voltage of the DC buss.

27. The method of claim 20, wherein the DC buss has a DC voltage ripple associated therewith, and wherein each of the energy receiving modules are protected from the DC voltage ripple by their respective converter modules.

28. The method of claim 20, further comprising the step of:
setting the DC buss voltage through the inverter.

29. The method of claim 20, further comprising the step of:
gathering information about one or more of the energy receiving modules with a communications module.

30. A system, comprising:
a plurality of DC to DC boost converters for parallel connection through a DC buss to an inverter module, wherein the inverter module comprises an inlet connected to a filter, a DC to AC converter having an input terminal, and an output terminal, wherein the input terminal is connected to the outlet of the filter, and wherein the output terminal is connectable to an AC power grid;
wherein each of the DC to DC boost converters comprises
an inlet for connection to the output of one or more DC power generation modules, wherein the corresponding one or more DC power generation modules supply DC power at a first voltage to the inlet of the DC to DC boost converter,
an outlet for connection to the filter of the inverter module through the DC buss, and
a DC to DC boost circuit, wherein the DC to DC boost circuit supplies DC power to the inlet of the filter of the inverter module at a second voltage, wherein the second voltage is higher than the first voltage.
